(19) United States
(12) Patent Application Publication
(10) Pub. No.: US 2025/0106912 A1
(43) Pub. Date: Mar. 27, 2025

(54) METHOD AND APPARATUS FOR PERFORMING DATA TRANSFER IN MOBILE WIRELESS COMMUNICATION SYSTEM

(71) Applicant: Soenghun KIM, Hanam-si (KR)

(72) Inventor: Soenghun KIM, Hanam-si (KR)

(21) Appl. No.: 18/896,394

(22) Filed: Sep. 25, 2024

(30) Foreign Application Priority Data
Sep. 26, 2023 (KR) 10-2023-0129303

(51) Int. Cl. H04W 76/11; H04L 1/00

(52) U.S. Cl. CPC H04W 76/11; H04L 1/0007

(57) ABSTRACT

A method and an apparatus for uplink transmission are provided. The method and apparatus facilitate overhead reduction signaling flexibility in uplink transmission. In the disclosure, the terminal and the base station performs uplink data transfer based on various formats for uplink packets.

### CROSS-REFERENCE TO RELATED APPLICATION

This application claims priority to and the benefit of Korean Patent Application No. 10-2023-0129303, filed on Sep. 26, 2023, the disclosure of which is incorporated herein by reference in its entirety.

### BACKGROUND

### Technical Field

The present disclosure relates to performing data transfer in wireless mobile communication system. More specifically, the present disclosure relates to uplink medium access control protocol unit and related subheaders.

### Related Art

To meet the increasing demand for wireless data traffic since the commercialization of 4th generation (4G communication systems), the 5th generation (5G system) is being developed. 5G system introduced millimeter wave (mmW) frequency bands (e. g. 60 GHz bands). In order to increase the propagation distance by mitigating propagation loss in the 5G communication system, various techniques are introduced such as beamforming, massive multiple-input multiple output (MIMO), full dimensional MIMO (FD-MIMO), array antenna, analog beamforming, and large-scale antenna. In addition, base station is divided into a central unit and plurality of distribute units for better scalability. To facilitate introduction of various services, 5G communication system targets supporting higher data rate and smaller latency. Various verticals such as IoT and smart device with reduced capability are deployed in the 5G mobile communication system.

Medium Access Control (MAC) Protocol Data Unit (PDU) is a general container that may carry various pieces of information which increase as verticals supported by 5G mobile communication system grow. The type of information is indicated by LCID index. As applicability of the NR system grows that result in increase of new information to be conveyed in the MAC PDU, demand for more LCID indexes is also increasing. In this disclosure, a solution to increase the number of LCID indexes while keeping the size of header minimum is provided.

### SUMMARY

Aspects of the present disclosure are to address the problems of uplink transmission. The method of the terminal includes receiving from a base station a system information and transmitting by the terminal to the base station a medium access control (MAC) protocol data unit (PDU) that comprises a MAC subheader indicating a specific logical channel identifier (LCID) index. In case that the specific LCID index is larger than a first LCID index and smaller than a second LCID index, a first field is set to a first value and a second field is set to a value corresponding to the specific LCID index. In case that the specific LCID index is equal to or larger than the second LCID index and smaller than a third LCID index, the first field is set to a second value and the second field is set to a value corresponding to the specific LCID index. In case that the specific LCID index is equal to or larger than the third LCID index, a first bit of the MAC subheader is set to one and the first field is set to a value corresponding to the specific LCID index.

### BRIEF DESCRIPTION OF THE DRAWINGS

FIG. 1A is a diagram illustrating the architecture of an 5G system and a NG-RAN to which the disclosure may be applied.

FIG. 1B is a diagram illustrating a wireless protocol architecture in an 5G system to which the disclosure may be applied.

FIG. 2A illustrates RRC connection setup procedure.

FIG. 2B illustrates RRC reconfiguration procedure.

FIG. 2C illustrates random access procedure.

FIG. 2D illustrates format of MAC PDU.

FIG. 2E illustrates format of MAC subheader.

FIG. 2F illustrates LCID index space.

FIG. 3A illustrates the operation of a UE and a base station.

FIG. 4A is a flow diagram illustrating an operation of a terminal.

FIG. 5A is a block diagram illustrating the internal structure of a UE to which the disclosure is applied.

FIG. 5B is a block diagram illustrating the configuration of a base station according to the disclosure.

### DETAILED DESCRIPTION

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, followings are used interchangeably:
Terminal and UE and wireless device;
Information Element (IE) and set of parameters;
Parameter and field and IE;
Base station and GNB.

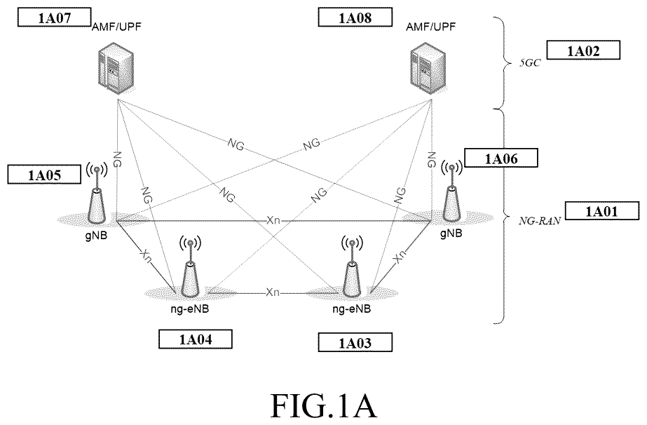

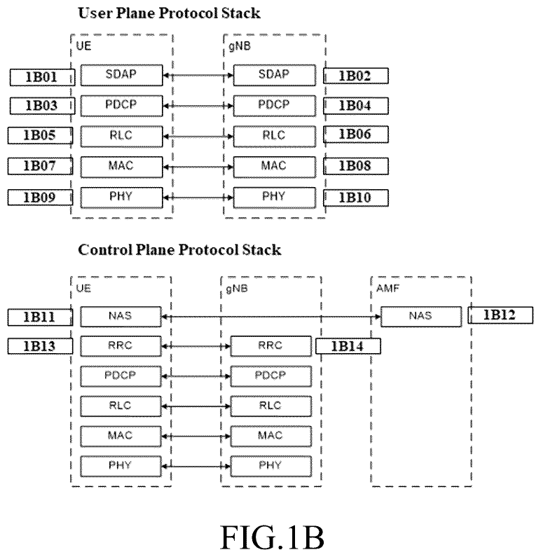

FIG. 1A is a diagram illustrating the architecture of an 5G system and a NG-RAN to which the disclosure may be applied.

5G system consists of NG-RAN 1A01 and 5GC 1A02. An NG-RAN node is either:
1: a gNB, providing NR user plane and control plane protocol terminations towards the UE; or
1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
1: Functions for Radio Resource Management such as Radio Bearer Control, Radio Admission Control, Connection Mobility Control, Dynamic allocation of resources to UEs in uplink, downlink and sidelink (scheduling); and
1: IP and Ethernet header compression, uplink data decompression and encryption of user data stream; and
1: Selection of an AMF at UE attachment when no routing to an MME can be determined from the information provided by the UE; and
1: Routing of User Plane data towards UPF; and
1: Scheduling and transmission of paging messages; and
1: Scheduling and transmission of broadcast information (originated from the AMF or O&M); and
1: Measurement and measurement reporting configuration for mobility and scheduling; and
1: Session Management; and
1: QOS Flow management and mapping to data radio bearers; and
1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

User plane protocol stack consists of SDAP 1B01 or 1B02, PDCP 1B03 or 1B04, RLC 1B05 or 1B06, MAC 1B07 or 1B08 and PHY 1B09 or 1B10. Control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

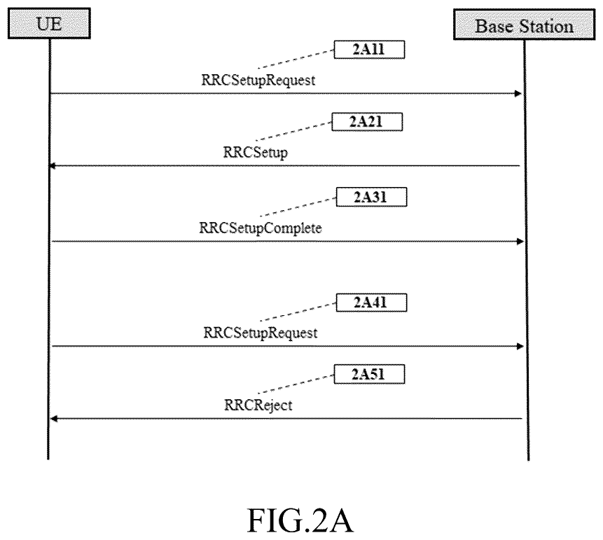

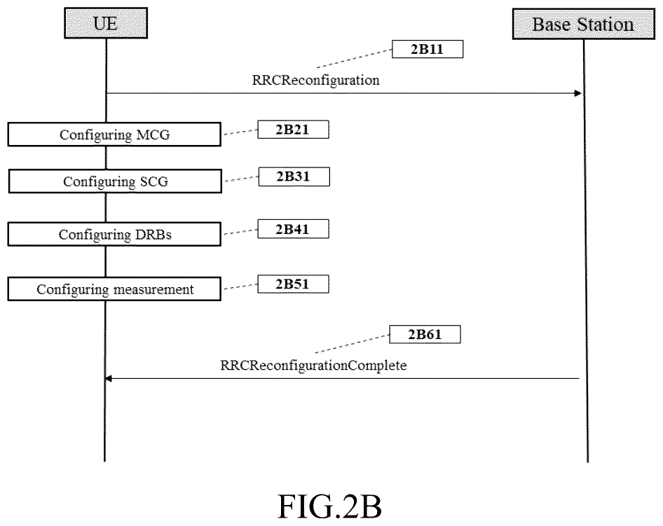

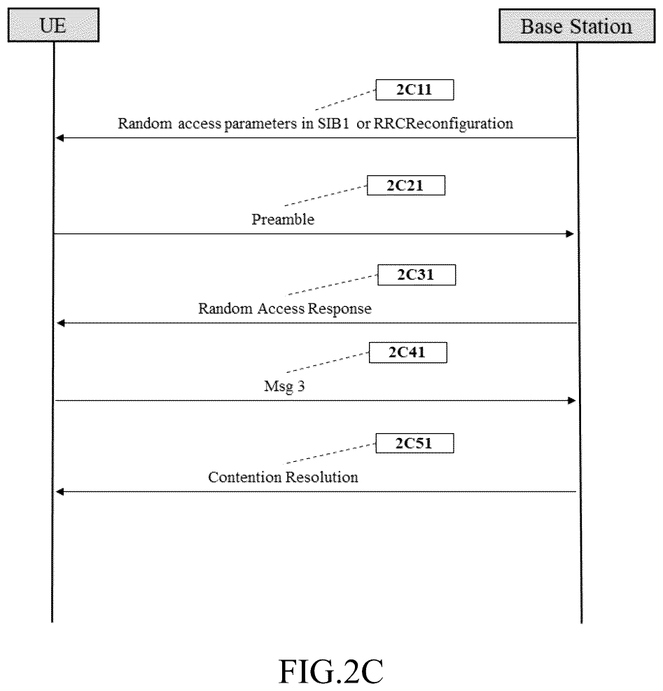

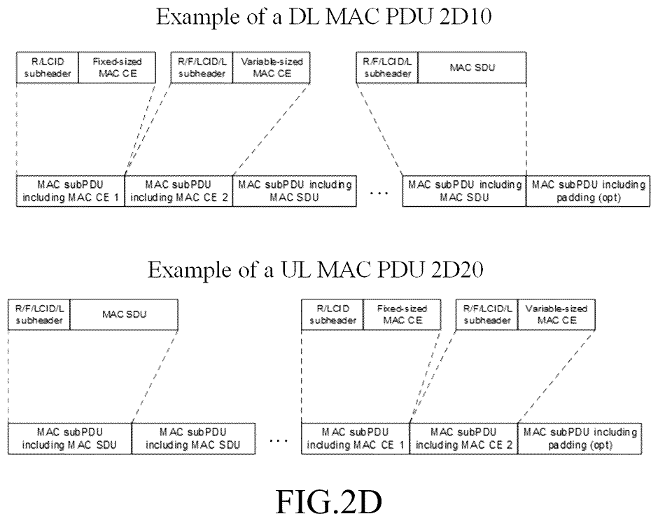

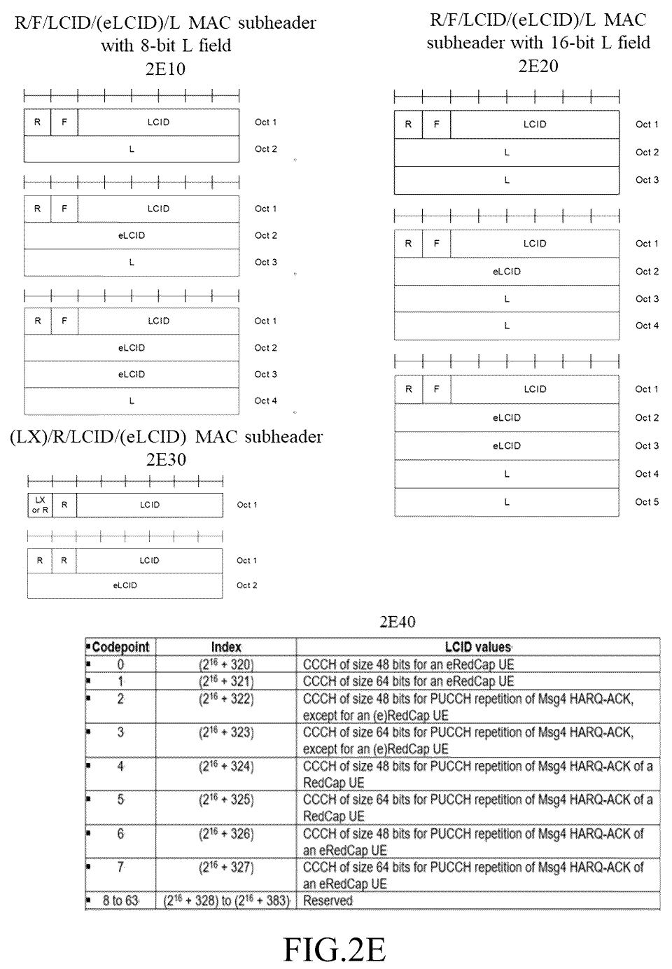

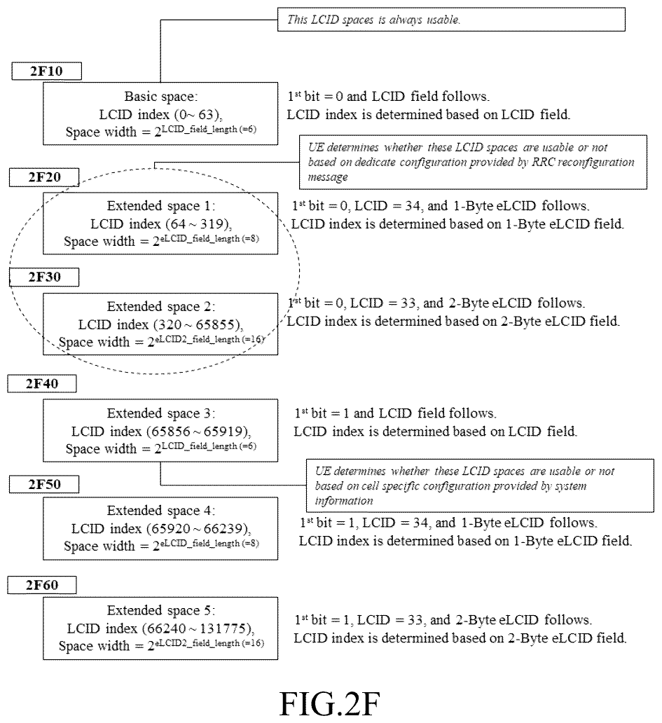

FIG. 2A illustrates RRC connection establishment procedure.

Successful RRC connection establishment procedure comprises:
1: transmission of RRCSetupRequest by the UE 2A11;
1: reception of RRCSetup by the UE 2A21;
1: transmission of RRCSetupComplete by the UE 2A31.

Unsuccessful RRC connection establishment procedure comprises:
1: transmission of RRCSetupRequest by the UE 2A41;
1: reception of RRCReject by the UE 2A51;

RRCSetupRequest comprises following fields and IEs:
>1: ue-Identity field contains InitialUE-Identity IE which contains:
   2: ng-5G-S-TMSI-Part1 field containing a BIT STRING of 39 bit;
1: establishmentCause field contains EstablishmentCause IE which contains:
   2 enumerated value indicating either emergency, highPriorityAccess, mt-Access, mo-Signalling, mo-Data, mo-VoiceCall, mo-VideoCall, mo-SMS, mps-PriorityAccess, mcs-PriorityAccess etc

RRCSetup comprises following fields and IEs:
1: radioBearerConfig field containing a RadioBearerConfig IE;
1: masterCellGroup field containing a CellGroupConfig IE.

RRCSetupComplete comprises following fields and IEs:
1: selectedPLMN-Identity field containing an integer indicating selected PLMN;
1: dedicatedNAS-Message field containing a DedicatedNAS-Message which may contain various NAS message;
1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identifies the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
1: perform the cell group configuration procedure in accordance with the received masterCellGroup;
1: perform the radio bearer configuration procedure in accordance with the received radioBearerConfig;
1: if stored, discard the cell reselection priority information provided by the cellReselectionPriorities or inherited from another RAT;
1: enter RRC_CONNECTED;
1: stop the cell re-selection procedure;
1: consider the current cell to be the PCell;

The UE transmits to the base station RRCSetupComplete after performing above actions.

The UE sets the contents of RRCSetupComplete message as follows:
1: set the ng-5G-S-TMSI-Value to ng-5G-S-TMSI-Part2;
1: set the selectedPLMN-Identity to the PLMN selected by upper layers from the plmn-IdentityInfoList;
1: include the s-NSSAI-List and set the content to the values provided by the upper layers;

FIG. 2B illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2B11 and RRCReconfigurationComplete 2B61 between the base station and the UE.

RRCReconfiguration may comprises following fields and IEs:
1: rrc-TransactionIdentifier field contains a RRC-TransactionIdentifier IE;
1: radioBearerConfig field contains a RadioBearerConfig IE;
   2: radioBearerConfig field comprises configuration information for SRBs and DRBs via which RRC messages and user traffic are transmitted and received;
1: secondaryCellGroup field contains a CellGroupConfig IE;
   2: secondaryCellGroup field comprises configuration information for secondary cell group;
   2: A cell group consists of a SpCell and zero or more SCells;
   2: Cell group configuration information comprises cell configuration information for SpCell/SCell and configuration information for MAC and configuration information for logical channel etc;
1: measConfig field contains a MeasConfig IE;
   2: measConfig field comprises configuration information for measurements that the UE is required to perform for mobility and other reasons.
1: masterCellGroup field contains a CellGroupConfig IE;

Upon reception of RRCReconfiguration, UE processes the IEs in the order as below. UE may:
1: perform the cell group configuration for MCG based on the received masterCellGroup 2B21;
1: perform the cell group configuration for SCG based on the received secondaryCellGroup 2B31;
1: perform the radio bearer configuration based on the received radioBearerConfig 2B41;
1: perform the measurement configuration based on the received measConfig 2B51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2C illustrates random access procedure.

Random access procedure enables the UE to align uplink transmission timing, and indicate the best downlink beam, and transmit a MAC PDU that may contain CCCH SDU (e.g. RRCSetupRequest).

Random access procedure comprises preamble transmission 2C21, random access response reception 2C31, Msg 3 transmission 2C41 and contention resolution 2C51.

Parameters for random access procedure are provided in SIB1 (in case of initial access) or in RRCReconfiguration (in case of handover) 2C11.

Random access procedure may be triggered by a number of events such as initial access from RRC_IDLE (e.g. RRC connection establishment procedure), DL or UL data arrival, request by RRC upon synchronous reconfiguration (e.g. handover) and RRC Connection Resume procedure from RRC_INACTIVE etc.

When the random access procedure is initiated, the UE may perform following actions in order:
1: flush the buffer for Msg 3;
1: initialize the counters for preamble transmission and power ramping;
1: select the uplink carrier for performing the random access procedure based on a rsrp threshold (e.g. rsrp-ThresholdSSB-SUL);
1: select the set of Random Access resources applicable to the current Random Access procedure;
1: select a SSB based on a rsrp threshold (e.g. rsrp-ThresholdSSB); a SSB corresponds to a downlink beam;
1: select a random access preamble group based on the pathloss of the selected SSB and the potential Msg3 size and various parameters (e.g. ra-Msg3SizeGroupA, preambleReceivedTargetPower, msg3-DeltaPreamble, messagePowerOffsetGroupB etc); Preamble group selection enables the UE to request bigger uplink grant for Msg 3 transmission if channel condition is good enough and the potential Msg 3 size is above a certain threshold;
1: select a random access preamble randomly with equal probability from the random access preambles associated with the selected SSB and the selected random access preamble group;
1: determine the next available PRACH occasion from the PRACH occasions corresponding to the selected SSB;
1: determine the transmission power of the preamble;
   2: preamble transmission power=pathloss+preambleReceivedTargetPower+DELTA_PREAMBLE+(PREAMBLE_POWER_RAMPING_COUNTER−1)×PREAMBLE_POWER_RAMPING_STEP+POWER_OFFSET_2STEP_RA
1: transmit the preamble in the determined PRACH occasion with the determined transmission power;
1; start ra-Response Window;
1: monitor the PDCCH of the SpCell for Random Access Response(s) identified by the RA-RNTI while the ra-Response Window is running;
1: receive Random Access Response contains a MAC subPDU with Random Access Preamble identifier corresponding to the transmitted preamble;
1: process the received Timing Advanced Command and the received UL grant;
1: transmit a Msg 3 based on the received UL grant;
   2: Msg 3 may contain e.g. CCCH SDU such as RRCSetupRequest or RRCResumeRequest;
1: start ra-ContentionResolutionTimer;
1: monitor the PDCCH while the ra-ContentionResolutionTimer is running;
1: consider Contention Resolution successful when MAC PDU containing a UE Contention Resolution Identity MAC CE is received;
1: consider the Random Access procedure successfully completed.

FIG. 2D illustrates MAC PDU format.

A MAC PDU is a bit string that is byte aligned (i.e. multiple of 8 bits) in length. Bit strings are represented by tables in which the most significant bit is the leftmost bit of the first line of the table, the least significant bit is the rightmost bit on the last line of the table, and more generally the bit string is to be read from left to right and then in the reading order of the lines. The bit order of each parameter field within a MAC PDU is represented with the first and most significant bit in the leftmost bit and the last and least significant bit in the rightmost bit.

A MAC SDU is a bit string that is byte aligned (i.e. multiple of 8 bits) in length. A MAC SDU is included into a MAC PDU from the first bit onward.

A MAC CE is a bit string that is byte aligned (i.e. multiple of 8 bits) in length.

A MAC subheader is a bit string that is byte aligned (i.e. multiple of 8 bits) in length. Each MAC subheader is placed immediately in front of the corresponding MAC SDU, MAC CE, or padding.

A MAC PDU consists of one or more MAC subPDUs. Each MAC subPDU consists of one of the following:
A MAC subheader only (including padding);
A MAC subheader and a MAC SDU;
A MAC subheader and a MAC CE; and
A MAC subheader and padding.

A DL MAC PDU 2D10 comprises MAC subPDUs for MAC CE first and MAC subPDUs for MAC SDU next. An UL MAC PDU 2D20 comprises MAC subPDUs for MAC SDU first and MAC subPDUs for MAC CE next. The difference is to ensure that UE have sufficient processing time for MAC SDUs (e.g. pre-processing).

FIG. 2E illustrates MAC subheader format.

Each MAC subheader corresponds to either a MAC SDU, a MAC CE, or padding.

A MAC subheader except for fixed sized MAC CE, padding, and a MAC SDU containing UL CCCH consists of the header fields R/F/LCID/(eLCID)/L 2E20. A MAC subheader for fixed sized MAC CE and padding consists of the header fields R/LCID/(eLCID) 2E10. A MAC subheader for a MAC SDU containing UL CCCH consists of the header fields (LX)/R/LCID 2E30.

MAC CEs are placed together. DL MAC subPDU(s) with MAC CE(s) is placed before any MAC subPDU with MAC SDU and MAC subPDU with padding. UL MAC subPDU(s) with MAC CE(s) is placed after all the MAC subPDU(s) with MAC SDU and before the MAC subPDU with padding in the MAC PDU.

The MAC subheader consists of the following fields:
LCID: The Logical Channel ID field identifies the logical channel instance of the corresponding MAC SDU or the type of the corresponding MAC CE or padding. There is one LCID field per MAC subheader. The size of the LCID field is 6 bits. If the LCID field is set to 34, one additional octet is present in the MAC subheader containing the eLCID field and follow the octet containing LCID field. If the LCID field is set to 33, two additional octets are present in the MAC subheader containing the eLCID field and these two additional octets follow the octet containing LCID field;
eLCID: The extended Logical Channel ID field identifies the logical channel instance of the corresponding MAC SDU or the type of the corresponding MAC CE. The size of the eLCID field is either 8 bits or 16 bits.
L: The Length field indicates the length of the corresponding MAC SDU or variable-sized MAC CE in bytes. There is one L field per MAC subheader except for subheaders corresponding to fixed-sized MAC CEs, padding, and MAC SDUs containing UL CCCH. The size of the L field is indicated by the F field;
F: The Format field indicates the size of the Length field. There is one F field per MAC subheader except for subheaders corresponding to fixed-sized MAC CEs, padding, and MAC SDUs containing UL CCCH. The size of the F field is 1 bit. The value 0 indicates 8 bits of the Length field. The value 1 indicates 16 bits of the Length field;
LX: The LCID extension field indicates the use of extended LCID space. The size of the LX field is 1 bit. The LX field set to 1 indicates the use of table 2E40, otherwise R bit is present instead (i.e. set to 0);

The MAC subheader is octet aligned.

FIG. 2F illustrates LCID index space and extension.

LCID index is an integer that is determined from one or more fields of a subheader. UE identifies a logical channel or a MAC CE based on the LCID index.

In the conventional NR system, LCID index is indicated by LCID field. With this approach, 64 LCID indexes are usable 2F10.

LCID spaces are extended by introducing eLCID field. The presence of eLCID field is indicated by specific values in LCID field. With 1-byte eLCID field, LCID index field is extended by 256 LCID indexes 2F20. With 2-byte eLCID field, LCID index field is further extended by 65536 LCID indexes 2F30.

If LCID space needs to be further extended, having longer eLCID field or having additional eLCID field is a straightforward approach. However, this further increase overhead which is sometimes unacceptable.

Instead, LCID space is further extended based on one of unused bit in MAC subheader as in 2F40, 2F50 and 2F60.

3 types of UL LCID field extension are used.
1: 1^{st} extension 2F20.
   2: If LCID indicates 33, the next byte is 1st eLCID field. 1st eLCID field indicates LCID index between 64 and 319.
1: 2^{nd} extension 2F30.
   2: If LCID indicates 34, the next two bytes are 2nd eLCID field. 2nd eLCID field indicates LCID index between 320 and (2¹⁶+319).
1: 3^{rd} extension
   2: If first bit (or second bit) of a MAC subheader is set to one, next 6 bits (or 6 LSBs of the byte) are 3^{rd} eLCID field. 3^{rd} eLCID field indicates LCID index between (2¹⁶+320) and (2¹⁶+383)
1: 1^{st} ELCID and 2nd ELCID can be used for 1st type MAC subheader (containing both LCID related fields and Length related field) and 2nd type MAC subheader (containing only LCID related fields).
1: 3^{rd} ELCID can be used only for 2nd type MAC subhead.
1: LCID related field includes LCID field and eLCID field.
1: Length related field includes F field and L field.
1: Basic LCID space 2F10 is always usable.
1: Extended LCID space 1 2F20 and Extended LCID space 2 2F30 are usable in case that at least one dedicate configuration related with those LCID spaces is enabled by a RRC message.
   2: UE can use 1^{st} specific code points of the 1^{st} ELCID if 1^{st} specific indication (or specific configuration information) is indicated in MAC-CellGroupConfig in dedicated RRC message (e.g. RRCReconfiguration or RRCSetup or RRCResum)
      3: The example of 1^{st} specific code point is index 296 (Enhanced Multiple Entry PHR (four octets Cᵢ)). The example of 1^{st} specific configuration information is information for enhanced multiple entry PHR configuration.
   2: UE can use 2nd specific code points of the 2nd ELCID if 2nd specific indication (or 2nd specific configuration information) is indicated in MAC-CellGroupConfig in dedicated RRC message (e.g. RRCReconfiguration or RRCSetup or RRCResum)>
1: Extended LCID space 3 2F40 is usable in case that at least one cell-specific configuration related with the LCID space is enabled by a system information.
   2: UE can use (3^{rd} specific code points of) the 3^{rd} ELCID if 3^{rd} specific indication (or 3^{rd} specific configuration information) is indicated in SIB1.
      3: The example of 3^{rd} specific code point is index 2¹⁶+321 (CCCH of size 48 bit requesting PUCCH repetition for Msg4 HARQ-ACK). The example of 3^{rd} specific configuration information is information on configuration of PUCCH repetition for Msg4 HARQ-ACK.
      3: The example of 3^{rd} specific code point is index 2¹⁶+322 (CCCH of size 48 bit indicating eRedCap UE).
      3: The example of 3^{rd} specific configuration information is information on configuration of eRedCap (e.g. initial bandwidth part for eRedCap)

If 3^{rd} specific configuration information is not configured/indicated in the SIB1, UE uses predefined LCID (e.g. 35=CCCH of 48 bit for RedCap UE or 52=CCCH of 48 bit except for RedCap UE and for eRedCap UE).

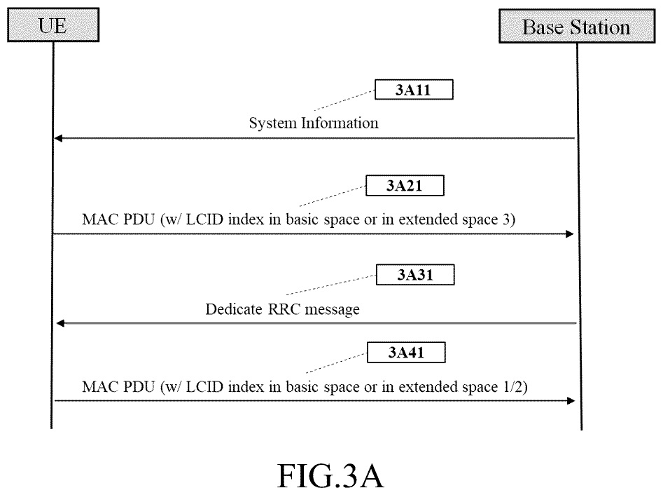

FIG. 3A illustrates operations of UE and GNB.

UE in RRC_IDLE state camps on a cell and receives a system information in the cell 3A11.

At some point of time, UE initiates RRC connection setup procedure. UE generates CCCH SDU which comprises specific RRC message requesting establishment of RRC connection.

UE multiplexes the CCCH SDU in a MAC PDU with LCID index that is selected either from basic space or from extended space 3. UE transmits the MAC PDU 3A21 during random access procedure.

After RRC connection establishment, GNB may decide to allocate dedicate resource/configuration for the UE. GNB transmits to the UE a dedicate RRC message 3A31 such as RRCReconfiguration or RRCSetup.

UE performs specific operation based on the information in the dedicate RRC message. For example, UE may trigger power headroom reporting procedure. Depending on PHR configuration in the dedicate RRC message, UE may use either LCID index in the basic space or LCID index in the extended space 1.

UE multiplexes the PHR MAC CE in a MAC PDU with LCID index that is selected either from basic space or from extended space 1. UE transmits the MAC PDU 3A41.

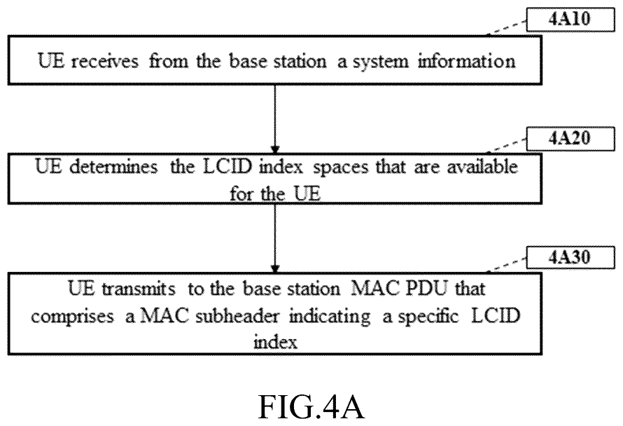

FIG. 4A is a flow diagram illustrating an operation of a terminal.

At 4A10, UE receives from the base station a system information.

At 4A20, UE determines the LCID index spaces that are available for the UE.

At 4A30, UE transmits to the base station MAC PDU that comprises a MAC subheader indicating a specific LCID index, wherein the LCID index is selected from the available LCID index spaces.

In case that the specific LCID index is larger than a first LCID index and smaller than a second LCID index [320]:
a first field [LCID] is set to a first value [33]; and
a second field [eLCID] is set to a value corresponding to the first LCID index.

In case that the specific LCID index is equal to or larger than the second LCID index and smaller than a third LCID index:
the first field [LCID] is set to a second value [34]; and
the second field [eLCID] is set to a value corresponding to the specific LCID index.

In case that the specific LCID index is equal to or larger than the third LCID index:
a first bit of the MAC subheader is set to one; and
the first field [LCID] is set to a value corresponding to the specific LCID index.

In case that the first bit of a MAC subheader is set to one, the MAC subheader does not comprise L field and F field.

In case that the first bit of the MAC subheader is set to zero and the first field indicates a specific value, the MAC subheader comprise L field and F field.

a LCID index that is greater than the third LCID index is applied in case that a specific configuration information is indicated in the system information.

a LCID index that is smaller than the third LCID index is applied in case that a second specific configuration information is indicated in a radio resource control (RRC) message.

The specific configuration information is configuration information on initial bandwidth part for reduced capability.

The second specific configuration information is configuration information on enhanced multiple entry power headroom configuration.

The specific configuration information is configuration information on physical uplink control channel repetition.

In case that the first bit of a MAC subheader is set to one:
the MAC subheader does not comprise a third field [L]; and
the MAC subheader does not comprise a fourth field [F].

In case that the first bit of a MAC subheader is set to zero and the first field indicates a specific value:
the MAC subheader comprise the third field [L]; and
the MAC subheader comprise the fourth field [F].

The third field indicates the length of the corresponding MAC control element (CE).

The fourth field indicates the length of the third field.

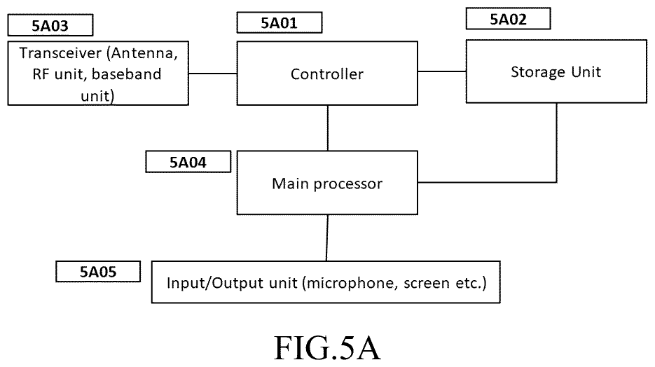

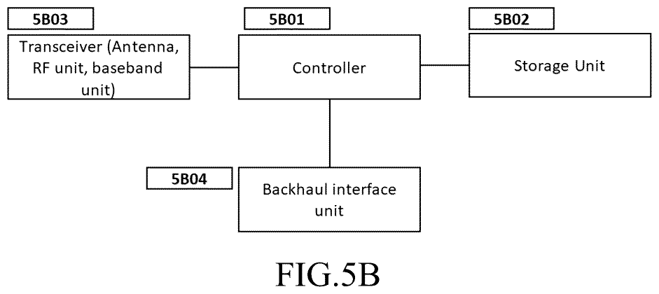

FIG. 5A is a block diagram illustrating the internal structure of a UE to which the disclosure is applied.

Referring to the diagram, the UE includes a controller 5A01, a storage unit 5A02, a transceiver 5A03, a main processor 5A04 and I/O unit 5A05.

The controller 5A01 controls the overall operations of the UE in terms of mobile communication. For example, the controller 5A01 receives/transmits signals through the transceiver 5A03. In addition, the controller 5A01 records and reads data in the storage unit 5A02. To this end, the controller 5A01 includes at least one processor. For example, the controller 5A01 may include a communication processor (CP) that performs control for communication and an application processor (AP) that controls the upper layer, such as an application program. The controller controls storage unit and transceiver such that UE operations in the present disclosure are performed.

The storage unit 5A02 stores data for operation of the UE, such as a basic program, an application program, and configuration information. The storage unit 5A02 provides stored data at a request of the controller 5A01.

The transceiver 5A03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor 5A04 controls the overall operations other than mobile operation. The main processor 5A04 process user input received from I/O unit 5A05, stores data in the storage unit 5A02, controls the controller 5A01 for required mobile communication operations and forward user data to I/O unit 5A05.

I/O unit 5A05 consists of equipment for inputting user data and for outputting user data such as a microphone and a screen. I/O unit 5A05 performs inputting and outputting user data based on the main processor's instruction.

FIG. 5B is a block diagram illustrating the configuration of a base station according to the disclosure.

As illustrated in the diagram, the base station includes a controller 5B01, a storage unit 5B02, a transceiver 5B03 and a backhaul interface unit 5B04.

The controller 5B01 controls the overall operations of the main base station. For example, the controller 5B01 receives/transmits signals through the transceiver 5B03, or through the backhaul interface unit 5B04. In addition, the controller 5B01 records and reads data in the storage unit 5B02. To this end, the controller 5B01 may include at least one processor. The controller controls transceiver, storage unit and backhaul interface such that base station operation in the present disclosure.

The storage unit 5B02 stores data for operation of the main base station, such as a basic program, an application program, and configuration information. Particularly, the storage unit 5B02 may store information regarding a bearer allocated to an accessed UE, a measurement result reported from the accessed UE, and the like. In addition, the storage unit 5B02 may store information serving as a criterion to deter mine whether to provide the UE with multi-connection or to discontinue the same. In addition, the storage unit 5B02 provides stored data at a request of the controller 5B01.

The transceiver 5B03 consists of a RF processor, a baseband processor and one or more antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mixer, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit 5B04 provides an interface for communicating with other nodes inside the network. The backhaul interface unit 5B04 converts a bit string transmitted from the base station to another node, for example, another base station or a core network, into a physical signal, and converts a physical signal received from the other node into a bit string.

What is claimed is:

1. A method performed by a terminal, the method comprising:
receiving, by the terminal from a base station, a system information; and
transmitting by the terminal to the base station a medium access control (MAC) protocol data unit (PDU) that comprises a MAC subheader indicating a specific logical channel identifier (LCID) index,
wherein in case that the specific LCID index is larger than a first LCID index and smaller than a second LCID index:
a first field is set to a first value; and
a second field is set to a first integer corresponding to the specific LCID index,
wherein in case that the specific LCID index is equal to or larger than the second LCID index and smaller than a third LCID index:
the first field is set to a second value; and
the second field is set to a second integer corresponding to the specific LCID index,
wherein in case that the specific LCID index is equal to or larger than the third LCID index:
a first bit of the MAC subheader is set to one; and
the first field is set to a third integer corresponding to the specific LCID index.

2. The method of claim 1, wherein:
a LCID index that is greater than the third LCID index is applied in case that a specific configuration information is indicated in the system information; and
a LCID index that is smaller than the third LCID index is applied in case that a second specific configuration information is indicated in a radio resource control (RRC) message.

3. The method of claim 2,
wherein the specific configuration information is configuration information on initial bandwidth part for reduced capability.

4. The method of claim 2,
wherein the second specific configuration information is configuration information on enhanced multiple entry power headroom configuration.

5. The method of claim 2,
wherein the specific configuration information is configuration information on physical uplink control channel repetition.

6. The method of claim 1, wherein in case that the first bit of the MAC subheader is set to one:
the MAC subheader does not comprise a third field; and
the MAC subheader does not comprise a fourth field.

7. The method of claim 6, wherein in case that the first bit of the MAC subheader is set to zero and the first field indicates a specific value:
the MAC subheader comprises the third field; and
the MAC subheader comprises the fourth field.

8. The method of claim 7, wherein:
the third field indicates length of corresponding MAC control element (CE); and
the fourth field indicates length of the third field.

9. A terminal comprising:
a transceiver,
a memory, and
a controller coupled to the transceiver and the memory, wherein the controller is configured to cause the terminal to:
receive from a base station, a system information, and
transmit to the base station a medium access control (MAC) protocol data unit (PDU) that comprises a MAC subheader indicating a specific logical channel identifier (LCID) index,
wherein in case that the specific LCID index is larger than a first LCID index and smaller than a second LCID index:
a first field is set to a first value; and
a second field is set to a first integer corresponding to the specific LCID index,
wherein in case that the specific LCID index is equal to or larger than the second LCID index and smaller than a third LCID index:
the first field is set to a second value; and
the second field is set to a second integer corresponding to the specific LCID index,
wherein in case that the specific LCID index is equal to or larger than the third LCID index:
a first bit of the MAC subheader is set to one; and
the first field is set to a third integer corresponding to the specific LCID index.
